(19) United States
(12) Patent Application Publication
(10) Pub. No.: US 2024/0060705 A1
(43) Pub. Date: Feb. 22, 2024

(54) REFRIGERANT CIRCULATION APPARATUS

(71) Applicants: HYUNDAI MOTOR COMPANY, Seoul (KR); KIA CORPORATION, Seoul (KR); HYUNDAI WIA CORPORATION, Seoul (KR)

(72) Inventors: Sang Shin Lee, Suwon-si (KR); Man Ju Oh, Yongin-si (KR); Ki Mok Kim, Busan (KR); Se Min Lee, Uiwang-si (KR); Bong Jun Park, Uiwang-si (KR); Man Hee Kim, Seoul (KR)

(21) Appl. No.: 18/120,242

(22) Filed: Mar. 10, 2023

(30) Foreign Application Priority Data
Aug. 16, 2022 (KR) 10-2022-0102326

(51) Int. Cl. F25D 23/00; F25B 41/40; F04B 39/00

(52) U.S. Cl. CPC F25D 23/006; F25B 41/40; F04B 39/0044; F25B 2500/13

(57) ABSTRACT

A refrigerant circulation apparatus includes a refrigerant circulation component including a compressor, a condenser, an expander, and an evaporator forming a refrigerant cycle through circulation of a refrigerant, and a support body in which the compressor is fixed to one side, the condenser, the expander, and the evaporator are sequentially disposed on the other side along the refrigerant cycle of the refrigerant, and a plurality of flow paths are formed so that the refrigerant flows between the condenser, the expander, and the evaporator.

### CROSS REFERENCE TO RELATED APPLICATIONS

The present application claims priority to Korean Patent Application No. 10-2022-0102326, filed on Aug. 16, 2022, the entire contents of which is incorporated herein for all purposes by this reference.

### BACKGROUND

### Field

The present disclosure relates to a refrigerant circulation apparatus in which respective parts through which a refrigerant is circulated are modularized so as to make a refrigerant line compact, which enables fixing means for fixing respective refrigerant-circulation parts to be deleted through such modularization, thereby reducing the weight and manufacturing cost.

### Description of the Related Art

Recently, electric vehicles are emerging as social issues for implementing environmentally friendly technology and solving a problem such as energy depletion. Electric vehicles operate using a motor that receives electricity from a battery and outputs power. Therefore, electric vehicles are in the spotlight as eco-friendly vehicles, since there is no emission of carbon dioxide, the noise is very small, and the energy efficiency of the motor is higher than that of an engine.

A key technology for realizing such an electric vehicle is a technology related to a battery module, and recent studies on light weight, miniaturization, and short charging time of batteries are being actively conducted. Battery modules need to be used in an optimal temperature environment to maintain optimal performance and long lifespan. However, it is difficult to use the battery module in an optimal temperature environment due to heat generated during operation and external temperature change.

In addition, since electric vehicles do not have a waste heat source generated during combustion in a separate engine like an internal combustion engine, the electric vehicles perform the indoor heating in winter with an electric heater, and the electric vehicles require warm-up to improve charge/discharge performance of batteries in a cold weather condition, the electric vehicles configure and use separate cooling water heating-type electric heaters. That is, in order to maintain an optimal temperature environment of a battery module, a technology for operating a heating/cooling system for controlling the temperature of a battery module separately from a heating/cooling system for indoor air-conditioning of a vehicle is used.

Here, in the case of an air conditioning system for indoor air-conditioning of a vehicle, a heat pump technology for minimizing heating energy consumption is applied to increase mileage, thereby minimizing energy consumption.

That is, an electric vehicle includes a refrigerant line through which a refrigerant is circulated, a coolant line through which a coolant is circulated for cooling electric components, and a coolant line through which a coolant is circulated for cooling a battery, thereby realizing a heat pump and the temperature of the coolant through heat exchange between the refrigerant and the coolant.

However, in the case of the refrigerant line, a plurality of parts forming a refrigerant cycle are configured, respective parts are fixed at different positions through separate brackets, and a refrigerant line extends between respective parts, thereby increasing the size of the refrigerant line.

However, recently, in order to secure thermal management efficiency and space, a method of reducing the refrigerant line is required.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and an objective of the present disclosure is to provide a refrigerant circulation apparatus in which respective parts through which a refrigerant is circulated are modularized so as to make a refrigerant line compact, which enables fixing means for fixing respective refrigerant-circulation parts to be deleted through such modularization, thereby reducing the weight and manufacturing cost.

In order to accomplish the above objective, according to an aspect of the present disclosure, there is provided a refrigerant circulation apparatus including a refrigerant circulation component including a compressor, a condenser, an expander, and an evaporator forming a refrigerant cycle through circulation of a refrigerant, and a support body in which the compressor is fixed to one side, the condenser, the expander, and the evaporator are sequentially disposed on the other side along the refrigerant cycle of the refrigerant, and a plurality of flow paths are formed so that the refrigerant flows between the condenser, the expander, and the evaporator.

The support body may be formed from an elastic material such that vibration transmitted from the compressor is absorbed.

The support body may be provided with a plurality of slit holes opened in a direction facing the compressor, the condenser, the expander, and the evaporator.

The support body may be provided such that one side thereof is formed to match an outer shape of the compressor, and the condenser, the expander, and the evaporator are disposed on the other side thereof.

The other side of the support body may be provided with a partition wall part dividing the condenser, the expander, and the evaporator, the partition wall part extending along an outer shape of the condenser, the expander, and the evaporator.

The refrigerant circulation component may further include a receiver dryer and an accumulator on the other side of the support body.

The compressor may be provided on one side of the support body, and the condenser, the receiver dryer, the expander, the evaporator, and the accumulator are sequentially arranged along the refrigerant cycle of the refrigerant in a clockwise or counterclockwise direction from the center on the other side of the support body.

The support body may include an inlet through which the refrigerant discharged from the compressor flows into the condenser, a first flow path through which the refrigerant discharged from the condenser flows into the receiver dryer, a second flow path through which the refrigerant discharged from the evaporator flows into the accumulator, and an outlet through which the refrigerant discharged from the accumulator is circulated to the compressor.

An outlet of the compressor and the inlet of the support body may be connected so that the refrigerant flows through a first pipe, and an inlet of the compressor and the outlet of the support body may be connected so that the refrigerant flows through a second pipe.

The first flow path and the second flow path may be formed separately from the support body and the support body may be provided with a first insertion groove and a second insertion groove such that the first flow path is fixedly inserted into the first insertion groove and the second flow path is fixedly inserted into the second insertion groove.

The support body may be formed from an elastic material to absorb vibration transmitted from the compressor, and the first flow path and the second flow path may be formed from a rigid body so as not to be deformed.

According to the refrigerant circulation apparatus having the above-mentioned configuration, respective parts through which a refrigerant is circulated are modularized so as to make a refrigerant line compact, which enables fixing means for fixing respective refrigerant-circulation parts to be deleted through such modularization, thereby reducing the weight and manufacturing cost.

It will be appreciated by those skilled in the art that the effects that can be achieved with the present disclosure are not limited to those described above and other advantages of the present disclosure will be clearly understood from the following detailed description.

### BRIEF DESCRIPTION OF THE FIGURES

FIG. 1 is a block diagram illustrating respective components according to a refrigerant cycle;

FIG. 2 is a diagram illustrating a refrigerant circulation apparatus according to an embodiment of the present disclosure;

FIG. 3 is an exploded perspective view illustrating the refrigerant circulation apparatus of FIG. 1;

FIG. 4 is a side view illustrating the refrigerant circulation apparatus of FIG. 1; and

FIG. 5 is a diagram illustrating a refrigerant flow in the refrigerant circulation apparatus of FIG. 1.

### DETAILED DESCRIPTION

Hereinafter, embodiments disclosed in the present specification will be described in detail with reference to the accompanying drawings, wherein the same or similar components are assigned the same reference numbers, and a redundant description thereof will be omitted.

The suffixes “module” and “part” for the components used in the following description are given or interchanged in consideration of only the ease of constructing the specification, and do not have distinct meanings or functions by themselves.

In addition, in describing the embodiments disclosed in the present specification, if it is determined that detailed descriptions of related known technologies may obscure the gist of the embodiments disclosed in the present specification, the detailed description thereof will be omitted. In addition, the accompanying drawings are only for easy understanding of the embodiments disclosed in the present specification so that the technical spirit disclosed herein is not limited by the accompanying drawings, so the accompanying drawings should be understood as covering all changes, equivalents, or substitutes included in the spirit and scope of the present disclosure.

It will be understood that although the terms “first”, “second”, etc. may be used herein to describe various elements, these elements should not be limited by these terms. These terms are only used to distinguish one element from another element.

It will be understood that when an element is referred to as being “connected” or “coupled” to another element, it can be directly connected or coupled to the other element or intervening elements may be present therebetween. In contrast, it will be understood that when an element is referred to as being “directly connected” to another element, there are no intervening elements present.

As used herein, the singular forms “a”, “an”, and “the” are intended to include the plural forms as well, unless the context clearly indicates otherwise.

It will be further understood that the terms “comprises” and/or “comprising”, or “includes” and/or “including”, when used in this specification, specify the presence of stated features, integers, steps, operations, elements, components or combinations thereof, but do not preclude the presence or addition of one or more other features, integers, steps, operations, elements, components, or combinations thereof.

Hereinafter, preferred embodiments of the present disclosure will be described with reference to the accompanying drawings.

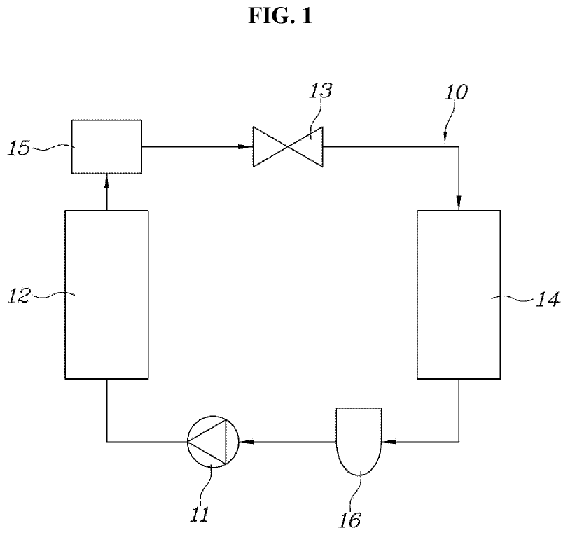

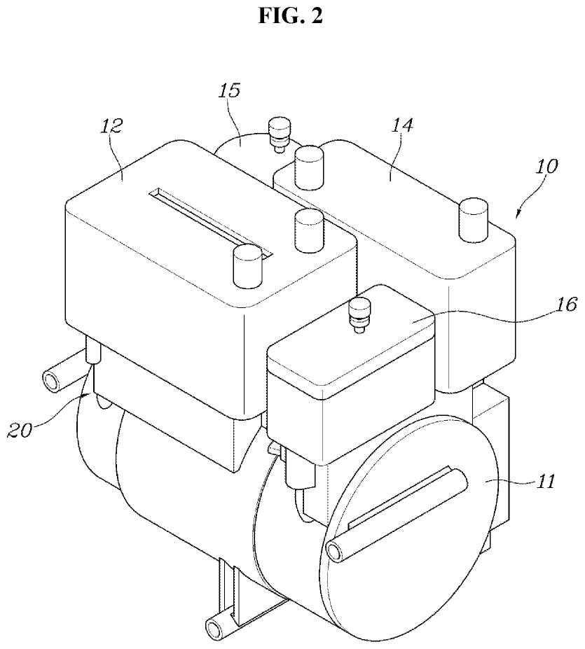

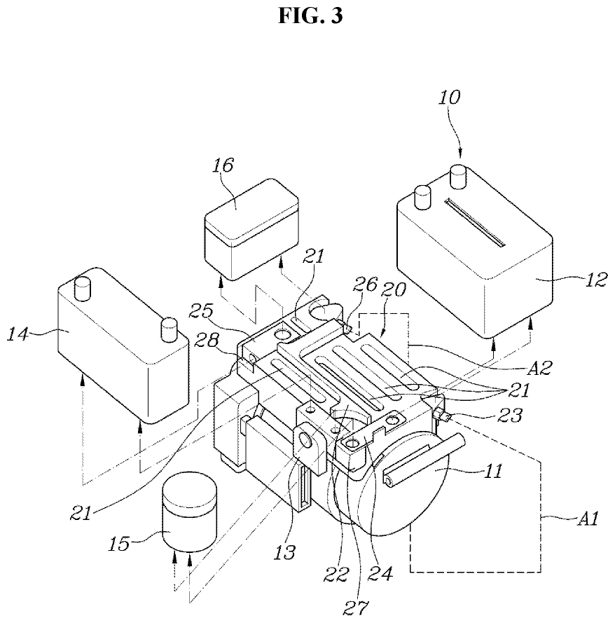

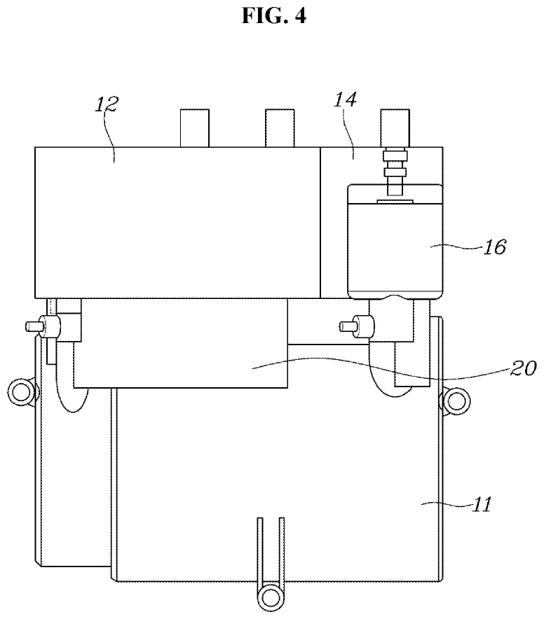

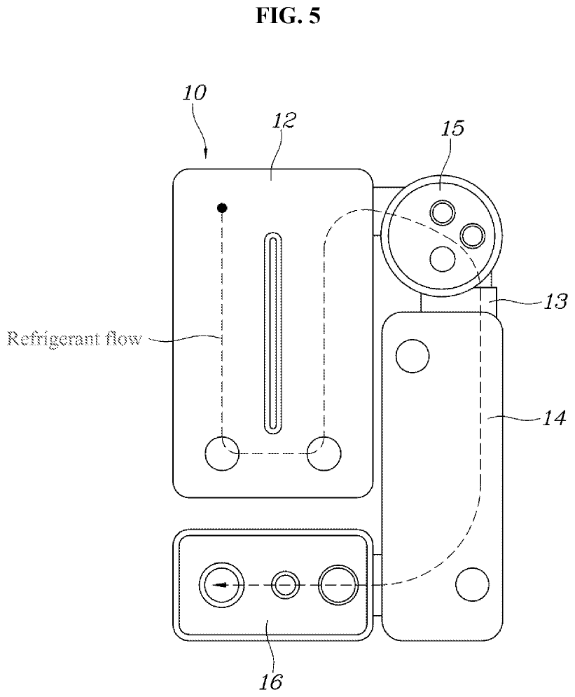

FIG. 1 is a block diagram illustrating respective components according to a refrigerant cycle, FIG. 2 is a diagram illustrating a refrigerant circulation apparatus according to an embodiment of the present disclosure, FIG. 3 is an exploded perspective view illustrating the refrigerant circulation apparatus of FIG. 1, FIG. 4 is a side view illustrating the refrigerant circulation apparatus of FIG. 1, and FIG. 5 is a diagram illustrating a refrigerant flow in the refrigerant circulation apparatus of FIG. 1.

The refrigerant circulation apparatus according to the present disclosure includes: a refrigerant circulation component 10 including a compressor 11, a condenser 12, an expander 13, and an evaporator 14 forming a refrigerant cycle through the circulation of a refrigerant, and a support body 20 in which the compressor 11 is fixed to one side, or a first side, thereof, the condenser 12, the expander 13, and the evaporator 14 are seated on the other side, or a second side thereof, and a plurality of flow paths are provided so that the refrigerant is circulated between the condenser, the expander 13, and the evaporator 14.

In the present disclosure, the refrigerant circulation component 10 includes the compressor 11, the condenser 12, the expander 13, and the evaporator 14 such that the refrigerant heat-exchanges with other heat exchange medium through the refrigerant cycle by sequential circulation of the refrigerant through the compressor 11, the condenser 12, the expander 13, and the evaporator 14. As an example, it may be configured such that coolant for cooling PE parts or coolant for cooling a battery heat-exchanges with a refrigerant through the condenser 12 or the evaporator 14 to implement a heat pump through temperature management of the refrigerant and the coolant.

Here, the refrigerant circulation component 10 may further include a receiver dryer 15 and an accumulator 16. Accordingly, as can be seen in FIG. 1, the refrigerant circulation component 10 may perform heat exchange with another heat exchange medium through the condenser 12 while the refrigerant compressed through the compressor 11 is condensed through the condenser 12. In addition, the refrigerant discharged from the condenser 12 may expand in the expander 13 after foreign substances and moisture are filtered through the receiver dryer 15, and may flow to the evaporator 14. Here, the refrigerant exchanges heat with another heat exchange medium through the evaporator 14, and is separated into a liquefied refrigerant and a gaseous refrigerant through the accumulator 16, so the gaseous refrigerant is circulated to the compressor 11.

Accordingly, the refrigerant circulation component 10 forms a circulation cycle in which a refrigerant sequentially circulates through the compressor 11, the condenser 12, the receiver dryer 15, the expander 13, the evaporator 14, and the accumulator 16.

In particular, in the present disclosure, the refrigerant circulation component 10 is integrated into the support body 20 so as to be modularized. That is, as illustrated in FIGS. 2 to 4, the compressor 11 is fixed to one side of the support body 20, and the condenser 12, the expander 13, and the evaporator 14 are seated on the other side of the support body 20, so that the refrigerant circulation component 10 is modularized with the support body 20.

The support body 20 is formed from an elastic material so that vibration can be absorbed. Accordingly, in the support body 20, since vibration generated as the compressor 11 is driven is not directly transmitted to the refrigerant circulation component 10 except for the compressor 11, damage to respective parts due to the vibration is prevented. That is, although the compressor 11 generates vibration during operation due to its structural characteristics, even if the refrigerant circulation component 10 is modularized with the support body 20, the support 20 attenuates the vibration generated by the compressor 11 so that the vibration generated by the compressor 11 is not directly transmitted to the condenser 12, the expander 13, and the evaporator 14, thereby maintaining the durability performance of the condenser 12, the expander 13, and the evaporator 14.

One side of the support body 20 may be formed to match an outer shape of the compressor 11, and the condenser 12, the expander 13, and the evaporator 14 may be disposed on the other side of the support body. As such, the support body 20 is formed to surround the compressor 11 since one side thereof matches the outer shape of the compressor 11, so that the compressor 11 may be firmly fixed to attenuate vibration generated by the compressor 11. In addition, since the refrigerant circulation component 10 excluding the compressor 11 is disposed on the other side of the support body 20, damage to the respective parts caused by the micro-vibration generated even if the vibration generated by the compressor 11 is attenuated by the support body 20 is avoided.

In addition, the support body 20 may be provided with a plurality of slit holes 21 opened in a direction facing the compressor 11, the condenser 12, the expander 13, and the evaporator 14.

As can be seen in FIG. 3, the plurality of slit holes 21 are formed in the support 20 to facilitate self-deformation of the support body 20, thereby improving the vibration attenuation effect. These slit holes 21 are opened in directions toward one side and the other side, and may be formed to extend a predetermined length. In addition, the plurality of slit holes 21 may be formed at positions matching the large-sized condenser 12 and evaporator 14 among the refrigerant circulation component 10 seated on the support body 20. The slit holes are preferably located so as not to interfere with flow paths and the other circulation parts.

On the other hand, as can be seen in FIG. 3, a partition wall part 22 is formed on the other side of the support body 20 to divide the condenser 12, the expander 13, and the evaporator 14, and the partition wall part 22 may extend along outer shapes of the condenser 12, the expander 13, and the evaporator 14. The partition wall part 22 extends to surround the other sides of the refrigerant circulation component 10 except for the compressor 11 on the other side of the support body 20, so that the condenser 12, the expander 13, and the evaporator 14 are stably fixed. In addition, since the partition wall part 22 surrounds the outer sides of the condenser 12, the expander 13, and the evaporator 14, the vibration attenuation effect of respective parts of the refrigerant circulation component 10 by the support body 20 is improved.

Meanwhile, as illustrated in FIG. 5, from the center of the other side of the support body 20, the condenser 12, the expander 13, and the evaporator 14 may be sequentially disposed along the refrigerant cycle of a refrigerant. In this way, parts of the refrigerant circulation component 10 fixed to the other side of the support body 20 may be arranged according to the order of the refrigerant cycle, and the parts of the refrigerant circulation component 10 are sequentially aligned and arranged clockwise or counterclockwise from the center of the support body 20, so that the refrigerant circulation through respective parts of the refrigerant circulation component 10 coupled to the support body 20 may be simplified, and thus the entire package may be reduced.

In detail, the compressor 11 may be disposed on one side of the support body 20, and the condenser 12, the receiver dryer 15, the expander 13, the evaporator 14, and the accumulator 16 may be sequentially disposed on the other side of the support body clockwise or counterclockwise along the refrigerant cycle.

Accordingly, the refrigerant discharged from the compressor 11 provided on one side of the support body 20 flows to the condenser 12 on the other side of the support body 20, and then flows clockwise or counterclockwise sequentially through the condenser 12, the receiver dryer 15, the expander 13, the evaporator 14, and the accumulator 16, so that the refrigerant circulation between the respective parts is facilitated. That is, during circulation through the refrigerant circulation component 10, the refrigerant naturally flows through the condenser 12, the receiver dryer 15, the expander 13, the evaporator 14, and the accumulator 16 arranged in a clockwise or counterclockwise direction on the other side of the support body 20 without an overlapped section. For this reason, even when the parts of the refrigerant circulation component 10 are modularized in the support body 20, a flow of refrigerant may be stabilized and the circulation path of the refrigerant may be formed in a shortest length.

To this end, the support body 20 may have the following detailed structure to form a refrigerant flow between the parts of the refrigerant circulation component 10. The support body 20 may have an inlet 23 through which a refrigerant discharged from the compressor 11 flows into the condenser 12, a first flow path through which the refrigerant discharged from the condenser 12 flows to the receiver dryer 15, a second flow path through which the refrigerant discharged from the evaporator 14 flows to the accumulator 16, and an outlet 26 through which the refrigerant discharged from the accumulator 16 flows to the compressor 11.

Here, an outlet of the compressor 11 and the inlet 23 of the support body 20 may be connected such that the refrigerant circulates through a first pipe A1, and an inlet of the compressor 11 and the outlet 26 of the support body 20 may be connected such that the refrigerant circulates through a second pipe A2. In the present disclosure, it may be configured such that the refrigerant discharged from the compressor 11 among the parts of the refrigerant circulation components 10 circulates through the other parts of the refrigerant circulation component 10 while passing through the support body 20. However, when a structure for circulation of the refrigerant is added to both sides of the support body 20, there is a problem in that the structure of the support body 20 itself becomes complicated and the size of the support body needs to be increased. Thus, it is preferable to connect the first pipe A1 and the second pipe A2 to the compressor 11 to form a refrigerant flow through the parts of the refrigerant circulation component 10 connected to the compressor 11.

On the other hand, the first flow path 24 and the second flow path 25 are formed separately from the support body 20 and the support body 20 has a first insertion groove 27 and a second insertion groove 28 formed therein. The first flow path 24 may be fixedly inserted into the first insertion groove 27, and the second flow path 25 may be fixedly inserted into the second insertion groove 28.

That is, the first flow path 24 and the second flow path 25 have through-flow channels through which the refrigerant can flow. When the first flow path 24 and the second flow path 25 are integrated into the support body 20, separate processing is required for forming the first flow path 24 and the second flow path 25 on the support body 20. However, it is difficult to form flow channels of the first flow path 24 and the second flow path 25.

In addition, the support body 20 may be configured to absorb vibrations generated by the compressor 11, and the first flow path 24 and the second flow path 25 may be separately formed form a rigid material to prevent deformation of the flow paths, thereby preventing the deformation of the flow paths through which the refrigerant flows.

Since the support body 20 according to the present disclosure described above is configured by the inlet 23, the first flow path 24, the second flow path 25, and the outlet 26, so that a flow of refrigerant through the parts of the refrigerant circulation component 10 can be formed.

That is, the first pipe A1 extending from the outlet of the compressor 11 may be connected to the inlet 23 of the support body 20, which is connected to an inlet of the condenser 12, so that as the refrigerant compressed in the compressor 11 flows to and is condensed by the condenser 12, heat exchange with a heat exchange medium may be performed.

The first flow path 24 may be configured in the support body 20, and an outlet of the condenser 12 and an inlet of the receiver dryer 15 may be connected to the first flow path 24, so that the refrigerant discharged from the condenser 12 may flow to the receiver dryer 15 through the first flow path 24.

In this way, the refrigerant in which foreign substances and moisture are filtered through the receiver dryer 15 flows to and expands at the expander 13, and then flows to the evaporator 14, so that as the refrigerant evaporates in the evaporator 14, heat exchange between the refrigerant and another heat exchange medium is performed.

In addition, the second flow path 25 may be configured in in the support body 20, and an outlet of the evaporator 14 and an inlet of the accumulator 16 may be connected to the second flow path 25, so that the refrigerant discharged from the evaporator 14 may flow to the accumulator 16 through the second flow path 25.

Meanwhile, the second pipe A2 extending from the inlet of the compressor 11 may be connected to the outlet 26 of the support body 20, which is connected to an outlet of the accumulator 16, so that the gaseous refrigerant separated through the accumulator 16 may be recirculated to the compressor 11.

In this way, the refrigerant circulation component 10 may be fixed to the support body 20 in a modularized state such that a smooth flow of refrigerant in the refrigerant circulation component 10 may occur through the inlet 23, the first flow path 24, the second flow path 25, and the outlet 26 of the support body 20.

Meanwhile, the support body 20 is formed from an elastic material to absorb vibration transmitted from the compressor 11, and the first flow path 24 and the second flow path 25 are formed from a rigid body so as not to be deformed.

As such, since the support body 20 is formed from an elastic material, vibration generated during driving of the compressor is not directly transmitted to the refrigerant circulation component 10 except for the compressor 11. On the other hand, the first flow path 24 and the second flow path 25 are formed from a rigid material to prevent shape deformation for smooth circulation of the refrigerant. Accordingly, the parts of the refrigerant circulation component 10 fixed to the support body 20 are prevented from being damaged by vibration, and as a flow of refrigerant through the first flow path 24 and the second flow path 25 is stabilized, smooth circulation of the refrigerant between the parts of the refrigerant circulation component 10 can be maintained.

According to the refrigerant circulation apparatus having the above-mentioned configuration, respective parts through which a refrigerant is circulated are modularized so as to make a refrigerant line compact, which enables fixing means for fixing respective refrigerant-circulation parts to be deleted through such modularization, thereby reducing the weight and manufacturing cost.

Although the present disclosure has been described and illustrated with respect to the specific embodiments, it would be obvious to those skilled in the art that various improvements and modifications are possible, without departing from the scope and spirit of the present disclosure as disclosed in the accompanying claims.

1. A refrigerant circulation apparatus, comprising:
a refrigerant circulation component including a compressor, a condenser, an expander, and an evaporator forming a refrigerant cycle through circulation of a refrigerant; and
a support body having the compressor fixed to a first side, the condenser, the expander, and the evaporator are sequentially positioned on a second side of the support body along the refrigerant cycle of the refrigerant, and a plurality of flow paths are formed in the support body so that the refrigerant flows between the condenser, the expander, and the evaporator.

2. The refrigerant circulation apparatus of claim 1, wherein the support body is formed from an elastic material such that vibration transmitted from the compressor is absorbed.

3. The refrigerant circulation apparatus of claim 1, wherein the support body comprises a plurality of slit holes opened in a direction facing the compressor, the condenser, the expander, and the evaporator.

4. The refrigerant circulation apparatus of claim 1, wherein the first side of the support body is formed to match an outer shape of the compressor, and the condenser, the expander, and the evaporator are positioned on the second side of the support body.

5. The refrigerant circulation apparatus of claim 1, wherein the second side of the support body is provided with a partition wall part dividing the condenser, the expander, and the evaporator, the partition wall part extending along an outer shape of the condenser, the expander, and the evaporator.

6. The refrigerant circulation apparatus of claim 1, wherein the refrigerant circulation component further includes a receiver dryer and an accumulator on the second side of the support body.

7. The refrigerant circulation apparatus of claim 6, wherein the compressor is provided on the first side of the support body, and the condenser, the receiver dryer, the expander, the evaporator, and the accumulator are sequentially arranged along the refrigerant cycle of the refrigerant in a clockwise or counterclockwise direction from the center on the second side of the support body.

8. The refrigerant circulation apparatus of claim 6, wherein the support body includes: an inlet through which the refrigerant discharged from the compressor flows into the condenser; a first flow path through which the refrigerant discharged from the condenser flows into the receiver dryer; a second flow path through which the refrigerant discharged from the evaporator flows into the accumulator; and an outlet through which the refrigerant discharged from the accumulator is circulated to the compressor.

9. The refrigerant circulation apparatus of claim 8, wherein an outlet of the compressor and the inlet of the support body are connected so that the refrigerant flows through a first pipe, and an inlet of the compressor and the outlet of the support body are connected so that the refrigerant flows through a second pipe.

10. The refrigerant circulation apparatus of claim 8, wherein the first flow path and the second flow path are formed separately from the support body, and the support body comprises a first insertion groove and a second insertion groove such that the first flow path is fixedly inserted into the first insertion groove and the second flow path is fixedly inserted into the second insertion groove.

11. The refrigerant circulation apparatus of claim 8, wherein the support body is formed from an elastic material to absorb vibration transmitted from the compressor, and the first flow path and the second flow path are formed from a rigid body.
